(19) United States
(12) Patent Application Publication
(10) Pub. No.: US 2009/0136133 A1
(43) Pub. Date: May 28, 2009

(54) Personalized fetal ultrasound image design

(76) Inventor: Kevin Thomas McGann, Aurora (CA)

Correspondence Address: Kevin McGann, 36 Victoria Street, Aurora, ON, L4G 1P9, CA

(21) Appl. No.: 11/986,652

(22) Filed: Nov. 26, 2007

(51) Int. Cl. G06K 9/34; G06K 9/00

(52) U.S. Cl. 382/176; 382/131

(57) ABSTRACT

(Process) the consumer submits their fetal ultrasound image along with an order form (includes requirements). The image is scanned and saved as a JPEG file or similar. If required the image is enhanced (cropped, brightness, etc.), saved and moved to Microsoft Publisher or similar software. The caption design and text, the phrase design and text, are created and saved in Microsoft Publisher/similar. The caption and phrase are placed over the fetal image, positioned and saved as a Publisher file. This file is the Personalized Fetal Ultrasound Image Design. Standard format is available to consumers. (Product) the Personalized Fetal Ultrasound Image Design is unique because it captures a personalized image of the fetus; a personalized caption; a personalized phrase. The personalized image can be copied, printed or transferred onto memorabilia and keepsakes such as t-shirts, pictures, mugs, blankets, magnets, bookmarks, etc. Each is unique, original, one of a kind.

The invention enables fetal ultrasound images, in whatever format, to be scanned, saved, copied, enhanced and personalized with phrases and captions creating a unique one of a kind image design.

### BACKGROUND OF THE INVENTION

There are companies that allow consumers to submit digital images on line or drop off at a location. These companies do not offer personalized captions to appear with the image. These companies do not offer personalized phrases to appear with the image. Some companies allow the consumer to zoom in/out, rotate, or flip the image but this is just to get the image positioned. There are no enhancements to the image. The image is then submitted to be transferred onto such fabric items as t-shirts, sweaters, canvas bags, pillow cases, quilts and so on; as well as cups, magnets, prints, calendars, bookmarks and other forms of memorabilia and keepsakes. Recently, with improvements in computer hardware, software and printable materials consumers have been given the option of creating personalized images and transferring these images onto memorabilia and keepsakes using their own home computer and printer.

Here are the problems. First, the images are required to be digital if they are going to be sent in electronically. Fetal ultrasound images are typically non-digital images. Which means the image would need to be scanned prior, either at home or by a company. Even if the image was dropped off at the store the image will still need to be scanned and saved onto a disc resulting in additional cost and time. Second, the image will not be enhanced; the image you drop off or send in will be the image that appears on the final product. Third, no companies offer personalized captions. Fourth, no companies offer personalized phrases. Fifth, not all consumers are comfortable with working on line and following the process of uploading their image. Sixth, many do not have the skills required in creating personalized images on their home computer. Seventh, many do not have the equipment or the time. Overall, companies that offer this type of service are limited in the choices that they can offer consumers when it comes to personalizing images. Their process is rigid and impersonal. Currently there is no company that provides the product that this invention will produce or has the process in place.

The invention addresses these problems. Images can be submitted electronically or hardcopy. The consumer completes an order form identifying their requirements. Images will be enhanced based on customer requirements. Personalized captions and phrases will be added based on customer requirements. Standard options in regards to enhancement, captions and phrases are also available. Over all the process is consumer based, user friendly and personal.

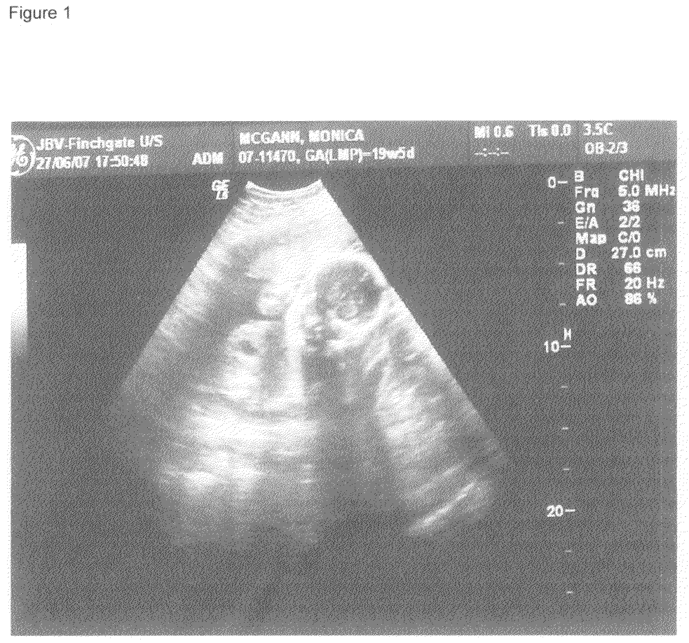

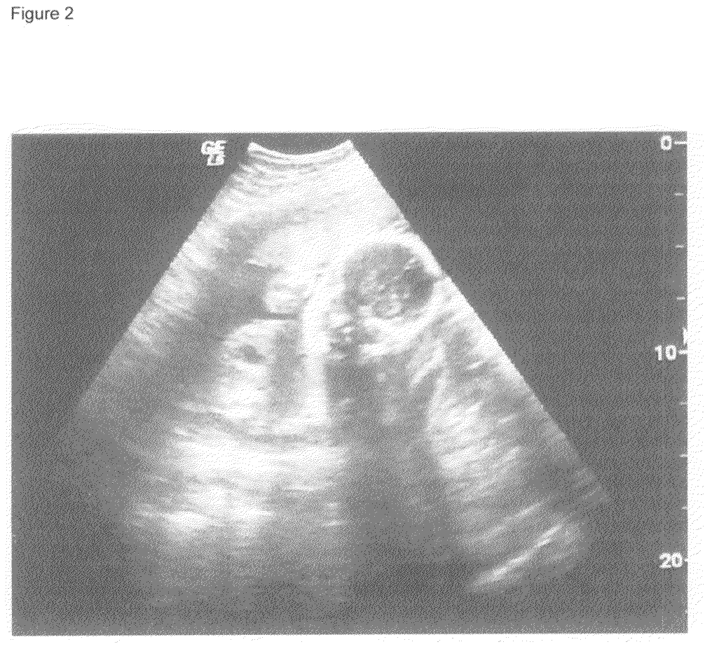

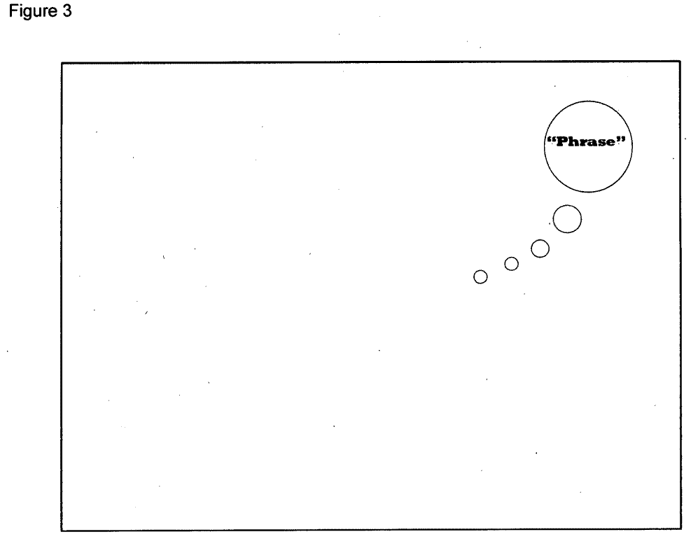

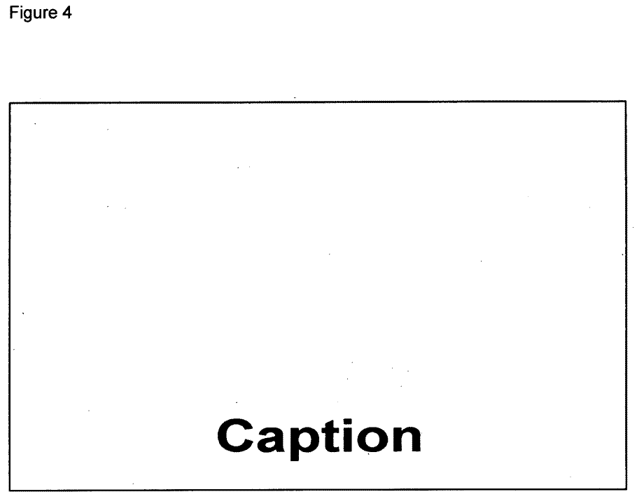

As mentioned, the Personalized Fetal Ultrasound Image Designs don't exist, nor does the process. Considered broadly, the invention enables the consumer to submit fetal ultrasound images as a hardcopy, in digital format, negative or other forms of media (FIG. 1). The consumer can request enhancements to the image by having such choices as cropping, brightness levels, subject matter (i.e. zoom in), and other image enhancement options (FIG. 2); or they can leave the image as is. The consumer is also allowed to choose from a variety of catch phrases and captions; or they can choose their own personalized phrase and/or caption; or they can choose none. The phrases will appear close to the fetus. One option for the phrase design is a large circle under which there are several circles each smaller in size than the previous and stopping at the fetus. This effect makes it look like the fetus is thinking the phrase. The text for the phrase appears in the largest circle. The circles give the effect of thinking bubbles (FIG. 3). Other shapes that will be used to give the effect of the baby thinking or talking the phrase are standard callouts or basic shapes, stars or banners; these will also be located close to the fetus. For phrase, consumers can choose the colour of the thinking bubbles, callouts, shapes, text boxes and text. The captions will appear as text (FIG. 4) or text within basic shapes, stars or banners. Captions will appear on or border the image. For captions consumer can choose the colour of the basic shapes, stars, banners and text.

In the drawings, which form a part of the specification,

FIG. 1 is an ultrasound picture of a fetus. The picture has been scanned and saved as a JPEG image.

FIG. 2 is the same fetal ultrasound image as FIG. 1 but has been enhanced—cropped and brightened.

FIG. 3 is an example of the phrase thinking bubble.

FIG. 4 is an example of a text caption.

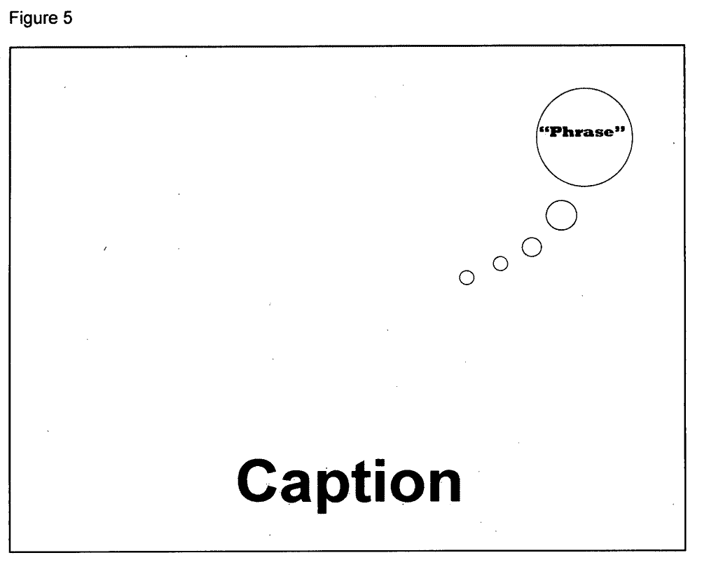

FIG. 5 is an example of the phrase (FIG. 3) and caption (FIG. 4).

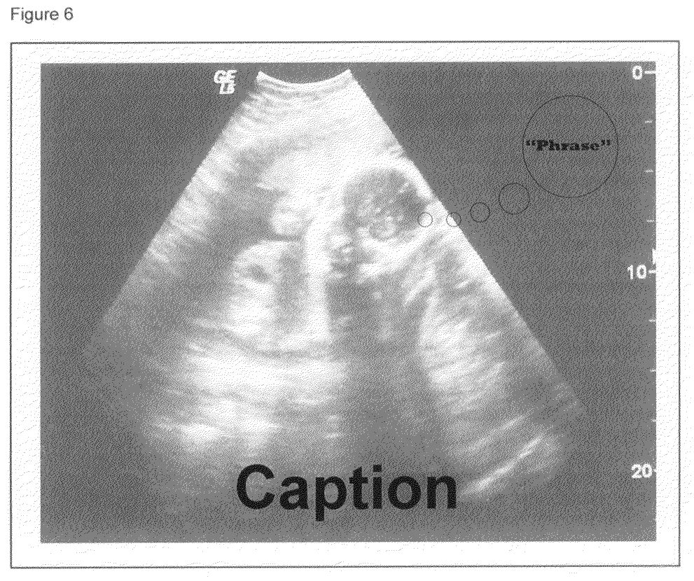

FIG. 6 is an example of the enhanced fetal ultrasound image (FIG. 2), the phrase thinking bubble and text caption (FIG. 5).

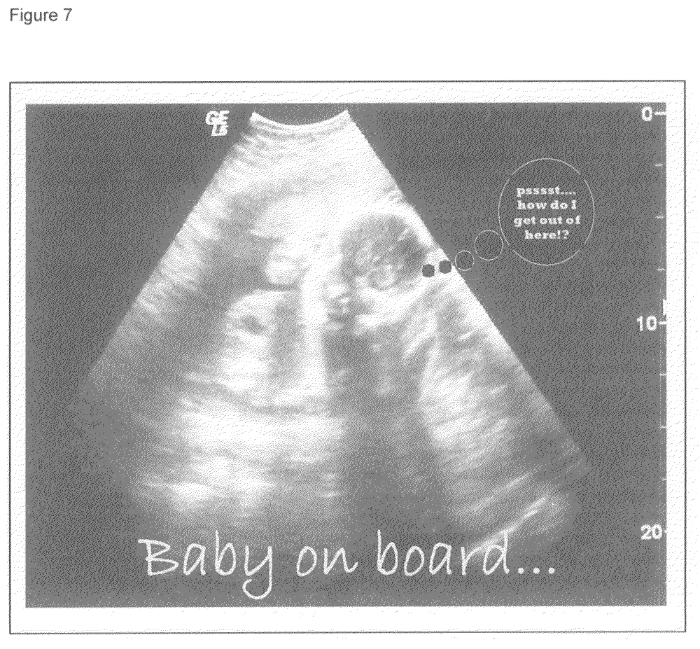

FIG. 7 is an example of a Personalized Fetal Ultrasound Image Design.

### SUMMARY OF THE INVENTION

The Personalized Fetal Ultrasound Image Design consists of an image of a fetus (FIG. 1) and can include none or one or more of the following: a phrase (FIG. 2) and/or a caption (FIG. 3). The phrase can be text in thought bubbles, callouts or basic shapes, stars or banners. The phrase text and shapes can be in colour, black or white. The caption can be text only or text within basic shapes, stars or banners. The caption text and shapes can be in colour, black or white.

The process for a Personalized Fetal Ultrasound Image Design is as follows;
1. The consumer submits a fetal ultrasound image along with a completed order form. If the image is digital it is saved. If hardcopy (i.e. picture, negative, slide, other) the image is scanned and saved as jpeg, gif, etc. (FIG. 1)
2. When requested by the consumer, the fetal ultrasound image is then enhanced to specifications of the consumer. (FIG. 2)
3. The fetal ultrasound image is then imported into Microsoft Publisher or similar software
4. The fetal ultrasound image is then sized according to specification of the consumer
5. When requested by the consumer, the captions and/or phrases are created, positioned, and saved (FIG. 3 and FIG. 4)
6. The saved phrases and captions phrases are placed (FIG. 5) over the fetal ultrasound image, positioned, and saved as a Publisher file. This file is the Personalized Fetal Ultrasound Image Design (FIG. 6)
7. If none, one or more phrase and/or caption was requested by the consumer this would be placed over the fetal ultrasound image, positioned and saved as a Personalized Fetal Ultrasound Image Design
8. More than one fetus can be included in one image (i.e. twins, triplets and so on)
9. The customer has the option of a standard format.
10. The Personalized Fetal Ultrasound Image Design can be copied, printed or transferred onto memorabilia and keepsakes using existing methods and processes available (FIG. 7).

The one intended use for the invention is to have the Personalized Fetal Ultrasound Image Design transferred onto fabrics for consumers. The transfer could be an iron-on, heated transfer, printed, and so on. Two broad examples would be a transfer for/onto maternity clothes for women; a transfer for/onto sports apparel.

The embodiments of the invention in which an exclusive property or privilege is claimed are defined as follows:

1. The Personalized Fetal Ultrasound Image Design consists of at a minimal, a fetal ultrasound image (FIG. 1);
Image can be non-digital, digital
Can be more than one fetus per image
Can be enhanced

2. The Personalized Fetal Ultrasound Image Design can consist of one or more phrase designs (FIG. 2);
Several different sized circles that give the effect of thinking bubbles
Other shapes that will be used to give the effect of the baby thinking or talking the caption are standard callouts or basic shapes, stars or banners
The design shapes can be in colour, black or white.
These designs will be located on the image close to the fetus or border the image
Phrase designs that are unique to organizations in #8

3. The Personalized Fetal Ultrasound Image Design can consist of one or more phrase design text (FIG. 2);
The text can be chosen from a pre-defined selection
The text can be chosen by the consumer
The text can be in colour, black or white.

4. The Personalized Fetal Ultrasound Image Design can consist of one or more caption designs (FIG. 3);
The caption design can be text only
Or the caption design can be text within basic shapes, stars or banners
Phrase will appear on or border the image
The design shapes will be in colour, black or white
Caption designs that are unique to organizations in #8

5. The Personalized Fetal Ultrasound Image Design can consist of one or more text captions (FIG. 3);
The text can be chosen from a pre-defined selection
The text can be chosen by the consumer
Can be text only or text within basic shapes, stars or banners
The text will be in colour, black or white

6. The Personalized Fetal Ultrasound Image Design pre-defined text phrases are as follows;
“psst . . . how do I get out of here!?”
“hey . . . who turned the lights on!?”
Phrases that are unique to organizations listed in #8

7. The Personalized Fetal Ultrasound Image Design pre-defined text captions are as follows;
Baby on board . . .
“Name of fetus” on board . . .
“Team Name” fan on board . . .
Captions unique to organizations listed in #8

8. Upon agreement from the organizations the Personalized Fetal Ultrasound Design Image can consist of captions and phrases which are unique to or become unique to;
NHL Teams
NFL Teams
NBA Teams
Major League Baseball
Major League Soccer
CFL Teams
Artistic Persons
Entertainment Persons
Musicians and Musical Groups
Private and Public Companies
Non Profit Organizations
Sporting Organizations
